(19) United States
(12) Patent Application Publication
(10) Pub. No.: US 2022/0250153 A1
(43) Pub. Date: Aug. 11, 2022

(54) TECHNICAL METHOD FOR PRINTING SIMILAR STRUCTURE OF COMBUSTION CHAMBER LINER BY USING GRCOP-84 SPHERICAL POWDER

(71) Applicant: SHAANXI SIRUI ADVANCED MATERIALS CO., LTD, Xi'an, Shaanxi (CN)

(72) Inventors: Xiaoyang LI, Xi'an (CN); Gaofeng YU, Xi'an (CN); Hang ZHANG, Xi'an (CN); Xuhong WU, Xi'an (CN); Wenbin WANG, Xi'an (CN); Mingyue MA, Xi'an (CN); Lin JING, Xi'an (CN)

(21) Appl. No.: 17/624,611

(22) PCT Filed: Jul. 6, 2020
(86) PCT No.: PCT/CN2020/100453

§ 371 Date: Jan. 4, 2022

(30) Foreign Application Priority Data
Jul. 6, 2019 (CN) 201910611052.5

(51) Int. Cl. B22F 10/28; B33Y 10/00; B33Y 40/10; B33Y 40/20; B22F 10/64; B22F 10/66; B22F 1/142; C22C 27/02

(52) U.S. Cl. CPC B22F 10/28; B33Y 10/00; B33Y 40/10; B33Y 40/20; B22F 10/64; B22F 2301/10; B22F 1/142; C22C 27/02; B22F 2201/02; B22F 2201/11; B22F 2301/20; B22F 10/66

(57) ABSTRACT

The present invention relates to the field of metal additive manufacturing, and disclosed thereby is a method for printing a structure of a combustion chamber liner by using GRCop-84 spherical powder. The method mainly comprises the following steps: (1) establishing a model; (2) configuring printing parameters; (3) performing laser printing; (4) performing annealing treatment; and (5) performing surface sandblasting. The present invention uses GRCop-84 spherical powder as the material of a combustion chamber liner model, and said material has excellent electrical conductivity, thermal expansion, strength, creep resistance, ductility, fatigue and like properties, and the comprehensive performance thereof is excellent, which significantly improves the performance of a rocket engine. In the GRCop-84 spherical powder material of the present invention, Cr and Nb form a Cr2Nb phase, and the volume fraction of a second phase is about 14%, same being evenly distributed in a copper matrix. Moreover, the second phase is still stable when 1600° C. is exceeded, which enables the material to maintain good service performance at high temperatures.

This application claims the priority of Chinese patent application No. CN 201910611052.5, filed on Jul. 6, 2019. This application quotes the full text of the aforementioned Chinese patent application.

### TECHNICAL FIELD

The present disclosure belongs to the field of metal additive manufacturing, and particularly relates to a method for printing a structure of combustion chamber liner by using GRCop-84 spherical powder.

### BACKGROUND

GRCop-84 alloy is the latest generation material of hydrogen-oxygen engine inner wall researched by the Glenn Research Center of the National Aeronautics and Space Administration of the United States. Cr and Nb in the GRCop-84 alloy form a Cr2Nb phase, and the volume fraction of a second phase is about 14%, same being evenly distributed in a copper matrix, and the second phase is still stable when 1600° C. is exceeded. Meanwhile, a large amount of Cr2Nb hardening phase can refine and control the grain size of copper to a large extent, which can further enhance the strength of copper alloy. Material engineers in NASA built several other test pieces, and tested and characterized the materials, the results showed that the thermal expansion of the GRCop-84 material was at least 7% lower than that of the previous generation alloy, the low thermal expansion leads to a small thermal stress inside the GRCop-84 material, which can extend the service life of the engine. The thermal conductivity of GRCop-84 material is about 70% to 83% of that of pure copper, which is slightly worse than the previous generation alloy, but far better than most materials with the same strength. In the test temperature range, the yield strength of GRCop-84 material is about twice that of the previous generation alloy. After the simulated brazing treatment, the residual strength of the GRCop-84 material is higher than that of the previous generation alloy. After a higher temperature treatment (such as hot isostatic pressing), some properties of the GRCop-84 material are reduced, but are still significantly better than the previous generation alloy. The Young's modulus of GRCop-84 material is lower than that of pure copper, thus the internal thermal stress of the material is smaller, which is beneficial to prolong the service life of the material. The creep and fatigue properties of GRCop-84 material are also far superior to the previous generation alloy.

Said material has excellent properties such as electrical conductivity, thermal expansion, strength, creep resistance, ductility, fatigue and the like, and the comprehensive performance thereof is excellent, which significantly improves the performance of a rocket engine. Based on the excellent performance of GRCop-84 material, core components of hydrogen-oxygen engine such as engine tail nozzles and engine combustion chamber liners have been trial-produced with said material by using additive manufacturing in foreign countries.

### CONTENT OF THE PRESENT INVENTION

In view of the above-mentioned problems, the present disclosure provides a method for printing a structure of combustion chamber liner by using GRCop-84 spherical powder.

The technical solutions of the present disclosure are as follows:

A method for printing a structure of combustion chamber liner by using GRCop-84 spherical powder, mainly comprising the following steps:

(1) Establishing a Model

Establishing a process model according to the structure of combustion chamber liner, which is placed vertically with the big head on the bottom and the small head on the top, and using a segmentation software to layer the model to form scanning paths for laser processing of each layer at the same time;

(2) Configuring Printing Parameters

Placing a back plate substrate, and spreading the GRCop-84 spherical powder over the powder cylinder, then configuring printing parameters, wherein, laser power: 250-450 W, laser spot diameter: 0.08-0.25 mm, laser processing scanning speed: 1000-1500 mm/s, single layer height: 0.02-0.15 mm, argon circulation wind speed control voltage in forming chamber: 2.5-4V;

(3) Performing Laser Printing

Turning on equipment to start vacuuming, and then filling with argon with a concentration of 99.99%-99.999% and starting printing, with a specific printing process as follows: using laser to scan the above-mentioned model of combustor liner layered by segmentation software layer by layer; after each layer is scanned, forming cylinder descends by one layer, and then powder cylinder rises by one layer, powder in powder cylinder is spread onto processed layer by a scraper to form a layer of copper powder, and then the powder cylinder descends; repeating for each layer until printing of the structure of combustion chamber liner is finished; oxygen concentration in the forming chamber is not more than 10 ppm;

(4) Performing Annealing Treatment

Putting the above-mentioned printed structure of combustion chamber liner into a vacuum furnace for vacuum annealing treatment, with a specific annealing process as follows: firstly, heating the structure of combustion chamber liner to 500-550° C., and then homogenizing for 8-10 min; secondly, heating the above structure to 600-800° C. at a heating rate of 45-55° C./h, and keeping it at this temperature for 25-45 min, and finally, cooling the structure of the combustion chamber liner after heat preservation treatment to room temperature, at a cooling rate of 15-20° C./h, wherein, the vacuum furnace is at a vacuum degree of 1×10⁻³-10×10⁻³ T;

(5) Performing Surface Sandblasting

After the above-mentioned annealing treatment, cutting and separating printed structure of combustion chamber liner from the substrate by wire cutting, and then performing sandblasting on surface of the structure of combustion chamber liner.

Further, the model established in the step (1) has an internal flow channel suspended at an angle of 0-10° with respect to vertical direction, if the internal flow channel is suspended at an angle beyond the range of 0−15° with respect to vertical direction, a support structure is needed to be added, and if the internal flow channel is suspended at an angle within this range, no support is needed to be added, and printing can be done directly, reducing the use of auxiliary support for printing.

Further, chemical composition in mass fraction of the GRCop-84 spherical powder in the step (2) is as follows: Cu 5-7 wt. %, Cr 4.5-6.5 wt. %, and Nb as the balance; gas elements in the GRCop-84 spherical powder: O≤500 ppm, N≤100 ppm, and particle size range of the powder is 15-65 μm; in material of the ingredient, Cr and Nb form a Cr2Nb phase, and the volume fraction of a second phase is about 14%, same being evenly distributed in a copper matrix, moreover, the second phase is still stable when 1600° C. is exceeded, which enables the material to maintain good service performance at high temperatures.

Further, before printing the GRCop-84 spherical powder in step (3), first performing plasma spheroidization pretreatment, with a specific treatment process as follows: putting GRCop-84 spherical powder and protective gas into a plasma torch, using high temperature in center of the plasma torch to heat the GRCop-84 spherical powder, quickly melting the above-mentioned GRCop-84 spherical powder to form metal droplets, which then enter powder spheroidization chamber and quickly condense; finally, separating the protective gas and the spheroidized powder from each other to obtain pure GRCop-84 spherical powder; wherein, the plasma torch has a RF power of 45-80 kw, an input flow rate of 30-50 L/min, and the protective gas has a pressure of 90-150 KPa; through the above pretreatment of GRCop-84 spherical powder, the porosity of GRCop-84 spherical powder can be reduced, the density of GRCop-84 spherical powder can be increased, the purity of GRCop-84 spherical powder can be improved, the oxygen content can be precisely controlled, and the printability performance of GRCop-84 can be improved.

Further, the protective gas is a mixed gas of argon and nitrogen, which helps to exhaust the oxygen while heating GRCop-84 spherical powder, to avoid oxidation reaction of GRCop-84 spherical powder, which may affect the purity of spheroidized powder.

Further, in the step (3), when a laser beam is used to scan layer by layer, dividing the scanning path by dichotomy, then using the laser beam to perform dual-direction scanning for each layer, specifically as follows: the scanning area is divided into two areas by taking the diameter of the bottom surface of the process model of the structure of combustion chamber liner as the dividing line, when scanning the first area, the scanning direction of the first laser beam is from left to right first, the direction of the second scanning line is from right to left, and the scanning direction between the subsequent adjacent laser beams is opposite; after the bottom layer scanning is completed, then scanning layer by layer from bottom to top following the above scanning method until the printing of the first area of the model is completed, and combining the second area with the first area after printing by the same printing method as described above; the jump distance between adjacent laser scanning beams is only the vertical distance between the two laser beams by means of sub-area and dual-direction scanning, which reduces the jump time of laser beams, thereby improving the processing efficiency of laser printing.

Further, in the step (6), when performing sandblasting on the surface of the printed structure of combustion chamber liner, at first, fixing the printed structure on the press-in dry sandblasting machine, and then sandblasting the surface of the structure of combustion chamber liner using 60-80 mesh quartz sand for 25-65 s under air pressure of 2.0-6.5 kgf/cm²; the above-mentioned sandblasting is performed on the surface of the structure of the combustion chamber liner to increase the surface roughness, thereby improving interface bonding strength between the coating and the surface of the structure.

Furthermore, when scanning GRCop-84 spherical powder with a laser beam, an ultrasonic impact device is used to impact the small dot-shaped molten pool and each layer of forming structure formed after scanning along the laser scanning track, wherein, the impact power is 800-1100 W, the impact frequency is 15-25 kHz, and the impact speed is 0.1 m-0.3 m/min; through the treatment of small molten pool and each layer of the forming structure with ultrasonic impact, a coarse columnar crystal structure existing in the forming structure after scanning is elongated and broken, so that the morphology of the prepared structure of combustion chamber liner gets refined.

The beneficial effects of the present invention are as follows:

(1) In the present invention, GRCop-84 spherical powder is used as the raw material of a model of combustion chamber liner, said material has excellent properties such as electrical conductivity, thermal expansion, strength, creep resistance, ductility fatigue and the like, and the comprehensive performance thereof is excellent, which significantly improves the performance of a rocket engine.

(2) In the present invention, laser beams are used to print a model of combustion chamber liner layered by a cutting software layer by layer, and cross-sectional shape of each layer will form a laser scanning track, and the powder on cross-sectional contour track of each layer forms a small dot-shaped molten pool after laser scanning, through the non-equilibrium solidification of the small molten pool, a super-solid solution state is formed with fine dendrites, uniform composition, and small degree of segregation, and by means of sub-area, dual-directional scanning, the jump distance between adjacent laser scanning beams is only the vertical distance between the two laser beams, which reduces the jump time of laser beams, thereby improving the processing efficiency of laser printing.

(3) In the present invention, the internal flow channel suspends at an angle within the range of 0-15° with respect to vertical direction, no supporting structure is needed to be added, printing can be done directly, and the use of printing auxiliary supports is reduced.

(4) In materials of GRCop-84 spherical powder in the present invention, Cr and Nb form a Cr2Nb phase, the volume fraction of a second phase is about 14%, same being evenly distributed in a copper matrix, moreover, the second phase is still stable when 1600° C. is exceeded, which enables the material to maintain good service performance at high temperatures.

(5) In the present invention, when performing annealing treatment on the formed structure of combustion chamber liner, a homogenizing temperature treatment is firstly performed to ensure the surface temperature of the structure of combustion chamber liner is uniform, to prevent excessive stress and surface cracks, and then by heating up and heat preservation, and finally cooling down, the tissue stress is eliminated, and the problem of cracks after annealing is solved.

(6) In the present invention, through performing plasma spheroidization pretreatment on the GRCop-84 spherical powder, the porosity of the GRCop-84 spherical powder is reduced, the density is increased, the purity is improved, the oxygen content is precisely controlled, and the printability performance of GRCop-84 spherical powder is improved.

(7) In the present invention, through treating the small molten pool and the forming structure of each layer by ultrasonic impact, a coarse columnar crystal structure in the formed structure after scanning is elongated and broken, so that the morphology of the prepared structure of combustion chamber liner gets refined.

### BRIEF DESCRIPTION OF THE DRAWINGS

FIG. 1 is a working flow chart of the present invention;

FIG. 2 is a process model diagram of a structure of combustion chamber liner of the present invention;

FIG. 3 is a bottom view of the process model diagram of a structure of combustion chamber liner of the present invention;

FIG. 4 is a scanning path diagram of laser beam of the present invention.

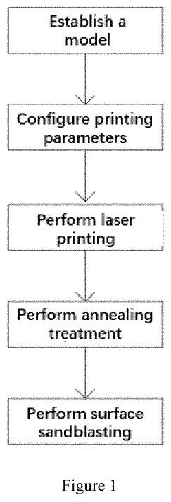

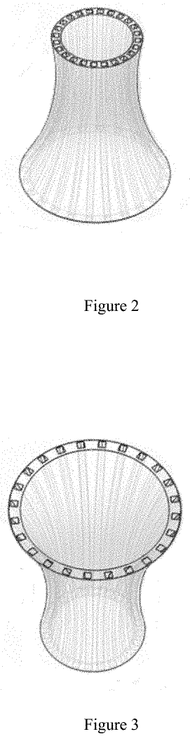

### DETAILED DESCRIPTION OF THE PREFERRED EMBODIMENT

The following examples further illustrate the schemes of the present disclosure in detail, but the scope of the present disclosure is not limited thereto.

### Example 1

A method for printing a structure of combustion chamber liner by using GRCop-84 spherical powder, mainly comprising the following steps:

(1) Establishing a Model

A process model was established according to the structure of combustion chamber liner, which has an internal flow channel suspended at an angle of 0° with respect to vertical direction, so that no support is needed to be added and printing can be performed directly, reducing the use of auxiliary support for printing; the model was placed vertically with the big head on the bottom and the small head on the top, and a segmentation software was used to layer the model to form scanning paths for laser processing of each layer;

(2) Configuring Printing Parameters

A back plate substrate was placed, GRCop-84 spherical powder was spread over the powder cylinder, and then printing parameters were configured, wherein, laser power: 250 W, laser spot diameter: 0.08 mm, laser processing scanning speed: 1000 mm/s, single layer height: 0.02 mm, argon circulation wind speed control voltage in forming chamber: 2.5V, chemical composition in mass fraction of GRCop-84 spherical powder are as follows: Cu 5 wt. %, Cr 4.5 wt. %, Nb as the balance, gas elements in the GRCop-84 spherical powder: O 500 ppm, N 100 ppm, and particle size of the powder is 15 μm. In the material of this component, Cr and Nb form a Cr2Nb phase, and the volume fraction of a second phase is 13%, same being evenly distributed in a copper matrix; moreover, the second phase is still stable when 1600° C. is exceeded, which enables the material to maintain good service performance at high temperatures;

(3) Performing Laser Printing

The equipment was turned on to start vacuuming, and then printing was started after argon with a concentration of 99.99% was filled in, with a specific printing process as follows: laser was used to scan the above-mentioned model of combustor liner layered by segmentation software layer by layer; after each layer was scanned, forming cylinder descended by one layer, and then powder cylinder rised by one layer, powder in powder cylinder was spread onto processed layer by a scraper to form a layer of copper powder, and then the powder cylinder descended; each layer was repeated until printing of the structure of combustion chamber liner was finished; the oxygen concentration in the forming chamber was 9 ppm;

(4) Performing Annealing Treatment

The above-mentioned printed structure of combustion chamber liner was put into a vacuum furnace for vacuum annealing treatment, with a specific annealing process as follows: firstly, the structure of combustion chamber liner was heated to 500° C., and then homogenized for 8 min; secondly, the above structure was heated to 600° C. at a heating rate of 45° C./h, and it was kept at this temperature for 25 min, and finally, the structure of the combustion chamber liner after heat preservation treatment was cooled down to room temperature, at a cooling rate of 15° C./h, wherein, the vacuum furnace was at a vacuum degree of 1×10⁻³ T;

(5) Performing Surface Sandblasting

After the above-mentioned annealing treatment, the printed structure of combustion chamber liner was cut and separated from the substrate by wire cutting, and then sandblasting was performed on surface of the structure of combustion chamber liner.

### Example 2

A method for printing a structure of combustion chamber liner by using GRCop-84 spherical powder, mainly comprising the following steps:

(1) Establishing a Model

A process model was established according to the structure of combustion chamber liner, which has an internal flow channel suspended at an angle of 5° with respect to vertical direction, so that no support is needed to be added and printing can be performed directly, reducing the use of auxiliary support for printing; the model was placed vertically with the big head on the bottom and the small head on the top, and a segmentation software was used to layer the model to form scanning paths for laser processing of each layer;

(2) Configuring Printing Parameters

A back plate substrate was placed, GRCop-84 spherical powder was spread over the powder cylinder, and then printing parameters were configured, wherein, laser power: 350 W, laser spot diameter: 0.15 mm, laser processing scanning speed: 1300 mm/s, single layer height: 0.1 mm, argon circulation wind speed control voltage in forming chamber: 3.2V, chemical composition in mass fraction of GRCop-84 spherical powder are as follows: Cu 6 wt. %, Cr 5.5 wt. %, Nb as the balance, gas elements in the GRCop-84 spherical powder: O 400 ppm, N 90 ppm, and particle size of the powder is 35 μm. In the material of this component, Cr and Nb form a Cr2Nb phase, and the volume fraction of a second phase is 14%, same being evenly distributed in a copper matrix; moreover, the second phase is still stable when 1600° C. is exceeded, which enables the material to maintain good service performance at high temperatures;

(3) Performing Laser Printing

The equipment was turned on, to start vacuuming, and then printing was started after argon with a concentration of 99.998% was filled in, with a specific printing process as follows: laser was used to scan the above-mentioned model of combustor liner layered by segmentation software layer by layer; after each layer was scanned, forming cylinder descended by one layer, and then powder cylinder rised by one layer, powder in powder cylinder was spread onto processed layer by a scraper to form a layer of copper powder, and then the powder cylinder descended; each layer was repeated until printing of the structure of combustion chamber liner was finished; the oxygen concentration in the forming chamber was 8 ppm;

(4) Performing Annealing Treatment

The above-mentioned printed structure of combustion chamber liner was put into a vacuum furnace for vacuum annealing treatment, with a specific annealing process as follows: firstly, the structure of combustion chamber liner was heated to 530° C., and then homogenized for 9 min; secondly, the above structure was heated to 700° C. at a heating rate of 50° C./h, and it was kept at this temperature for 35 min, and finally, the structure of the combustion chamber liner after heat preservation treatment was cooled down to room temperature, at a cooling rate of 18° C./h, wherein, the vacuum furnace was at a vacuum degree of 5×10⁻³ T;

(5) Performing Surface Sandblasting

After the above-mentioned annealing treatment, the printed structure of combustion chamber liner was cut and separated from the substrate by wire cutting, and then sandblasting was performed on surface of the structure of combustion chamber liner.

Although the present invention has been described in detail with reference to the foregoing embodiments, those skilled in the art should understand that: these are only examples, and various changes or modifications can be made to these embodiments without departing from the principle and essence of the present invention. Therefore, the scope of the present invention is defined by the appended claims.

### Example 3

A method for printing a structure of combustion chamber liner by using GRCop-84 spherical powder, mainly comprising the following steps:

(1) Establishing a Model

A process model was established according to the structure of combustion chamber liner, which has an internal flow channel suspended at an angle of 10° with respect to vertical direction, so that no support is needed to be added and printing can be performed directly, reducing the use of auxiliary support for printing; the model was placed vertically with the big head on the bottom and the small head on the top, and a segmentation software was used to layer the model to form scanning paths for laser processing of each layer;

(2) Configuring Printing Parameters

A back plate substrate was placed, GRCop-84 spherical powder was spread over the powder cylinder, and then printing parameters were configured, wherein, laser power: 450 W, laser spot diameter: 0.25 mm, laser processing scanning speed: 1500 mm/s, single layer height: 0.15 mm, argon circulation wind speed control voltage in forming chamber: 4V, chemical composition in mass fraction of GRCop-84 spherical powder are as follows: Cu 7 wt. %, Cr 6.5 wt. %, Nb as the balance, gas elements in the GRCop-84 spherical powder: O 300 ppm, N 80 ppm, and particle size of the powder is 65 μm. In the material of this component, Cr and Nb form a Cr2Nb phase, and the volume fraction of a second phase is 15%, same being evenly distributed in a copper matrix; moreover, the second phase is still stable when 1600° C. is exceeded, which enables the material to maintain good service performance at high temperatures;

(3) Performing Laser Printing

The equipment was turned on, to start vacuuming, and then printing was started after argon with a concentration of 99.999% was filled in, with a specific printing process as follows: laser was used to scan the above-mentioned model of combustor liner layered by segmentation software layer by layer; after each layer was scanned, forming cylinder descended by one layer, and then powder cylinder rised by one layer, powder in powder cylinder was spread onto processed layer by a scraper to form a layer of copper powder, and then the powder cylinder descended; each layer was repeated until printing of the structure of combustion chamber liner was finished; the oxygen concentration in the forming chamber was 7 ppm;

(4) Performing Annealing Treatment

The above-mentioned printed structure of combustion chamber liner was put into a vacuum furnace for vacuum annealing treatment, with a specific annealing process as follows: firstly, the structure of combustion chamber liner was heated to 550° C., and then homogenized for 10 min; secondly, the above structure was heated to 800° C. at a heating rate of 55° C./h, and it was kept at this temperature for 45 min, and finally, the structure of the combustion chamber liner after heat preservation treatment was cooled down to room temperature, at a cooling rate of 20° C./h, wherein, the vacuum furnace was at a vacuum degree of 10×10⁻³ T;

(5) Performing Surface Sandblasting

After the above-mentioned annealing treatment, the printed structure of combustion chamber liner was cut and separated from the substrate by wire cutting, and then sandblasting was performed on surface of the structure of combustion chamber liner.

### Example 4

A method for printing a structure of combustion chamber liner by using GRCop-84 spherical powder, mainly comprising the following steps: this embodiment is basically the same as Example 2, with a difference as follows: before GRCop-84 spherical powder was printed in step (3), plasma spheroidization pretreatment was first performed with a specific treatment process as follows: GRCop-84 spherical powder and the mixed gas of argon and nitrogen with a volume ratio of 6:7 were put into a plasma torch, and high temperature in center of the plasma torch use was used to heat GRCop-84 spherical powder, and the above-mentioned GRCop-84 spherical powder was quickly melted to form metal droplets, which then entered powder spheroidization chamber and quickly condensed; finally, the protective gas and the spheroidized powder were separated from each other to obtain pure GRCop-84 spherical powder, wherein, the plasma torch had a radio frequency power of 60 kw, an input flow rate of 40 L/min, and the protective gas had a pressure of 110 KPa, through the above pretreatment of GRCop-84 spherical powder, the porosity of GRCop-84 spherical powder can be reduced, the density of GRCop-84 spherical powder can be increased, the purity of GRCop-84 spherical powder can be improved, the oxygen content can be precisely controlled, and the printability performance of GRCop-84 can be improved.

### Example 5

This embodiment is basically the same as embodiment Example 4, with a difference as follows: as shown in FIG. 4, in step (3), when a laser beam was used to scan layer by layer, the scanning path was divided by dichotomy, then the laser beam was used to perform dual-direction scanning for each layer, specifically as follows: the scanning area was divided into two areas by taking the diameter of the bottom surface of the process model of the structure of combustion chamber liner as the dividing line, when the first area was being scanned, the scanning direction of the first laser beam was from left to right first, the direction of the second scanning line was from right to left, and the scanning direction between the subsequent adjacent laser beams was opposite; after the bottom layer scanning was completed, then layer by layer from bottom to top was scanned following the above scanning method until the printing of the first area of the model was completed, and the second area, after printed by the same printing method as described above, was combined with the first area; the jump distance between adjacent laser scanning beams was only the vertical distance between the two laser beams by means of sub-area and dual-direction scanning, which reduced the jump time of laser beams, thereby improving the processing efficiency of laser printing.

### Example 6

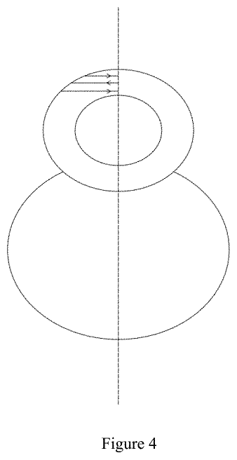

This embodiment is basically the same as Example 5 with a difference as follows: as shown in FIG. 3, when sandblasting was performed on the surface of the printed structure of combustion chamber liner in step (6), at first, the printed structure was fixed on the press-in dry sandblasting machine, and then the surface of the structure of combustion chamber liner was sandblasted using 70 mesh quartz sand for 45 s under air pressure of 4.5 kgf/cm²; the above-mentioned sandblasting was performed on the surface of the structure of the combustion chamber liner to increase the surface roughness, thereby improving interface bonding strength between the coating and the surface of the structure.

### Example 7

This embodiment is basically the same as Example 6 with a difference as follows: when GRCop-84 spherical powder was scanned with a laser beam, an ultrasonic impact device was used to impact the small dot-shaped molten pool and each layer of forming structure formed after being scanned along the laser scanning track, wherein, the impact power was 1100 W, the impact frequency was 25 kHz, and the impact speed was 0.3 m/min; through the treatment of small molten pool and each layer of the forming structure with ultrasonic impact, a coarse columnar crystal structure existing in the forming structure after scanning was elongated and broken, so that the morphology of the prepared structure of combustion chamber liner got refined.

Finally, it should be noted that the above embodiments are only used to illustrate the solutions of the present invention, but not to limit them; although the present invention has been described in detail with reference to the foregoing embodiments, those of ordinary skilled in the art should understand that: the solutions recorded in the embodiments can be modified, or some of the features thereof can be equivalently replaced; these modifications or replacements do not cause the essence of the corresponding solutions to deviate from the spirit and scope of the solutions of the embodiments of the present invention.

What is claimed is:

1. A method for printing a structure of combustion chamber liner by using GRCop-84 spherical powder, mainly comprising the following steps:
(1) Establishing a model
Establishing a process model according to the structure of combustion chamber liner, which is placed vertically with the big head on the bottom and the small head on the top, and using a segmentation software to layer the model to form scanning paths for laser processing of each layer at the same time;
(2) Configuring printing parameters
Placing a back plate substrate, and spreading the GRCop-84 spherical powder over the powder cylinder, then configuring printing parameters, wherein, laser power: 250-450 W, laser spot diameter: 0.08-0.25 mm, laser processing scanning speed: 1000-1500 mm/s, single layer height: 0.02-0.15 mm, argon circulation wind speed control voltage in forming chamber: 2.5-4V;
(3) Performing laser printing
Turning on equipment to start vacuuming, and then filling with argon with a concentration of 99.99%-99.999% and starting printing, with a specific printing process as follows: using laser to scan the above-mentioned model of combustor liner layered by segmentation software layer by layer; after each layer is scanned, forming cylinder descends by one layer, and then powder cylinder rises by one layer, powder in powder cylinder is spread onto processed layer by a scraper to form a layer of copper powder, and then the powder cylinder descends; repeating for each layer until printing of the structure of combustion chamber liner is finished; oxygen concentration in the forming chamber is not more than 10 ppm;
(4) Performing annealing treatment
Putting the above-mentioned printed structure of combustion chamber liner into a vacuum furnace for vacuum annealing treatment, with a specific annealing process as follows: firstly, heating the structure of combustion chamber liner to 500-550° C., and then homogenizing for 8-10 min; secondly, heating the above structure to 600-800° C. at a heating rate of 45-55° C./h, and keeping it at this temperature for 25-45 min, and finally, cooling the structure of the combustion chamber liner after heat preservation treatment to room temperature, at a cooling rate of 15-20° C./h, wherein, the vacuum furnace is at a vacuum degree of 1×10⁻³-10×10⁻³ T;
(5) Performing surface sandblasting
After the above-mentioned annealing treatment, cutting and separating printed structure of combustion chamber liner from the substrate by wire cutting, and then performing sandblasting on surface of the structure of combustion chamber liner.

2. The method for printing the structure of combustion chamber liner by using GRCop-84 spherical powder according to claim 1, wherein the process model established in the step (1) has an internal flow channel suspended at an angle of 0-10° with respect to vertical direction.

3. The method for printing the structure of combustion chamber liner by using GRCop-84 spherical powder according to claim 1, wherein chemical composition in mass fraction of the GRCop-84 spherical powder in the step (2) is as follows: Cu 5-7 wt. %, Cr 4.5-6.5 wt. %, and Nb as the balance; gas elements in the GRCop-84 spherical powder: O≤500 ppm, N≤100 ppm, and particle size range of the powder is 15-65 μm.

4. The method for printing the structure of combustion chamber liner by using GRCop-84 spherical powder according to claim 1, wherein, before printing the GRCop-84 spherical powder in step (3), first performing plasma spheroidization pretreatment, with a specific treatment process as follows: putting GRCop-84 spherical powder and protective gas into a plasma torch, using high temperature in center of the plasma torch to heat the GRCop-84 spherical powder, quickly melting the above-mentioned GRCop-84 spherical powder to form metal droplets, which then enter powder spheroidization chamber and quickly condense; finally, separating the protective gas and the spheroidized powder from each other to obtain pure GRCop-84 spherical powder; wherein, the plasma torch has a RF power of 45-80 kw, an input flow rate of 30-50 L/min, and the protective gas has a pressure of 90-150 KPa.

5. The method for printing the structure of combustion chamber liner by using GRCop-84 spherical powder according to claim 4, wherein the protective gas is a mixed gas of argon and nitrogen.

6. The method for printing the structure of combustion chamber liner by using GRCop-84 spherical powder according to claim 1, wherein, in the step (3), when a laser beam is used to scan layer by layer, dividing the scanning path by dichotomy, then using the laser beam to perform dual-direction scanning for each layer, specifically: the scanning area is divided into two areas by taking the diameter of the bottom surface of the process model of the structure of combustion chamber liner as the dividing line, when scanning the first area, the scanning direction of the first laser beam is from left to right first, the direction of the second scanning line is from right to left, and the scanning direction between the subsequent adjacent laser beams is opposite; after the bottom layer scanning is completed, then scanning layer by layer from bottom to top following the above scanning method until the printing of the first area of the model is completed, and combining the second area with the first area after printing by the same printing method as described above.

7. The method for printing the structure of combustion chamber liner by using GRCop-84 spherical powder according to claim 1, wherein in the step (6), when performing sandblasting on the surface of the printed structure of combustion chamber liner, at first, fixing the printed structure on the press-in dry sandblasting machine, and then sandblasting the surface of the structure of combustion chamber liner using 60-80 mesh quartz sand for 25-65 s under air pressure of 2.0-6.5 kgf/cm².
